(19) United States
(12) Patent Application Publication
(10) Pub. No.: US 2025/0140847 A1
(43) Pub. Date: May 1, 2025

(54) COATED ACTIVE MATERIAL, POSITIVE ELECTRODE MATERIAL, AND BATTERY

(71) Applicant: Panasonic Intellectual Property Management Co., Ltd., Osaka (JP)

(72) Inventors: KAORI SHINODA, Osaka (JP); YUTA SUGIMOTO, Hyogo (JP); AKINOBU MIYAZAKI, Osaka (JP)

(21) Appl. No.: 19/004,037

(22) Filed: Dec. 27, 2024

Related U.S. Application Data
(63) Continuation of application No. PCT/JP2023/022753, filed on Jun. 20, 2023.

(30) Foreign Application Priority Data
Aug. 2, 2022 (JP) 2022-123584
Oct. 7, 2022 (JP) 2022-162742

(51) Int. Cl. H01M 4/525; H01M 4/02; H01M 4/131; H01M 4/36; H01M 10/052; H01M 10/0562

(52) U.S. Cl. CPC H01M 4/525; H01M 4/131; H01M 4/364; H01M 10/052; H01M 10/0562; H01M 2004/021; H01M 2004/028; H01M 2300/008

(57) ABSTRACT

A coated active material of the present disclosure is a coated active material including an active material and a coating layer containing a first solid electrolyte and coating at least part of the surface of the active material. The first solid electrolyte contains Li, M1, O, and X1. M1 is at least one selected from the group consisting of Ta and Nb. X1 is at least one selected from the group consisting of F, Cl, Br, and I. The thickness of the coating layer is greater than 0 nm and less than or equal to 75 nm. A molar ratio Li/M1 of Li to M1 is greater than or equal to 0.60 and less than or equal to 2.4. A molar ratio O/X1 of O to X1 is greater than or equal to 0.16 and less than or equal to 0.35.

### BACKGROUND

### 1. Technical Field

The present disclosure relates to a coated active material, a positive electrode material, and a battery.

### 2. Description of the Related Art

WO 2021/220924 discloses a battery containing a positive electrode material in which at least part of the surface of a positive electrode active material is coated with an oxyhalide solid electrolyte.

### SUMMARY

One non-limiting and exemplary embodiment provides a coated active material that can reduce the interfacial resistance of a battery.

In one general aspect, the techniques disclosed here feature a coated active material comprising an active material and a coating layer comprising a first solid electrolyte and coating at least part of a surface of the active material, in which the first solid electrolyte comprises Li, M1, O, and X1, M1 is at least one selected from the group consisting of Ta and Nb, X1 is at least one selected from the group consisting of F, Cl, Br, and I, a thickness of the coating layer is greater than 0 nm and less than or equal to 75 nm, a molar ratio Li/M1 of Li to M1 is greater than or equal to 0.60 and less than or equal to 2.4, and a molar ratio O/X1 of O to X1 is greater than or equal to 0.16 and less than or equal to 0.35.

The present disclosure can reduce the interfacial resistance of a battery.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a sectional view of a schematic configuration of a coated active material in a first embodiment;

FIG. 2 is sectional view of a schematic configuration of a positive electrode material in a second embodiment;

FIG. 3 is a sectional view of a schematic configuration of a battery in a third embodiment;

FIG. 4 is a graph of an X-ray diffraction pattern of a first solid electrolyte;

FIG. 5 is a Nyquist diagram of a battery in Example 1 at 3.85 V;

FIG. 6 is a Nyquist diagram of a battery in Example 2 at 3.85 V;

FIG. 7 is a Nyquist diagram of a battery in Example 3 at 3.85 V; and

FIG. 8 is a Nyquist diagram of a battery in Comparative Example 1 at 3.85 V.

### DETAILED DESCRIPTIONS

### Underlying Knowledge Forming Basis of the Present Disclosure

WO 2021/220924 states that the charge-discharge efficiency of a battery can be improved by using a positive electrode material in which at least part of the surface of a positive electrode active material is coated with an oxyhalide solid electrolyte.

The present inventors have found that while lithium ion transfer is facilitated in an active material interface coated with an electrolyte, electron transfer determines the rate, which in turn causes an increase in interfacial resistance and a reduction in characteristics. To solve this problem, the thickness of coating is required to be optimized.

Embodiments of the present disclosure will be described below with reference to the drawings.

### First Embodiment

A coated active material according to a first embodiment includes an active material and a coating layer containing a first solid electrolyte and coating at least part of the surface of the active material. The first solid electrolyte contains Li, M1, O, and X1. M1 is at least one selected from the group consisting of Ta and Nb. X1 is at least one selected from the group consisting of F, Cl, Br, and I. The thickness of the coating layer is greater than 0 nm and less than or equal to 75 nm.

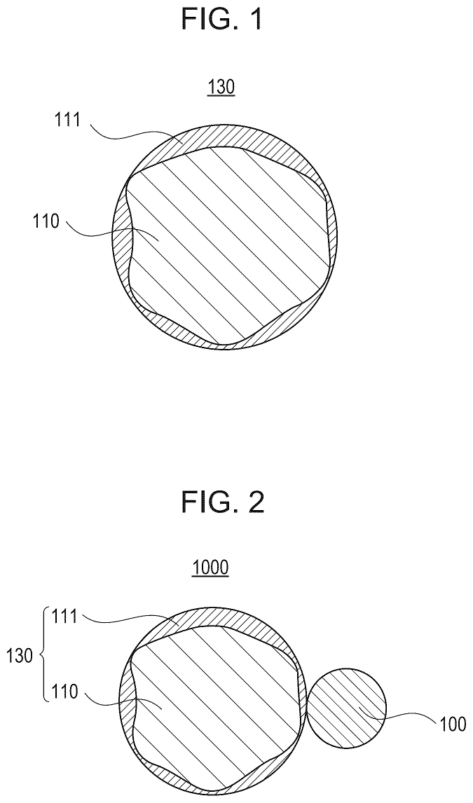

FIG. 1 is a sectional view of a schematic configuration of a coated active material 130 in the first embodiment. The coated active material 130 in the first embodiment includes an active material 110 and a coating layer 111. The shape of the active material 110 is, for example, a particle shape. The coating layer 111 coats at least part of the surface of the active material 110.

The coating layer 111 is a layer containing the first solid electrolyte. The coating layer 111 is provided on the surface of the active material 110.

When the coating layer 111 is included, lithium ion transfer in the interface of the active material 110 is facilitated. When the thickness of the coating layer 111 is set to less than or equal to 75 nm, the contact between the active materials 110 improves, and electronic resistance can be reduced. That is, the thickness of the coating layer 111 is thin enough to ensure physical contact between the active materials 110 after the coating layer 111 is crushed when the coated active materials 130 are compression bonded, and thus, electronic resistance can be reduced. Thus, the coated active material 130 according to the first embodiment can reduce the interfacial resistance of a battery.

The thickness of the coating layer 111 can be determined by, for example, performing cross section processing by a method of ion milling and directly observing a cross section with a scanning electron microscope (SEM). The thickness can be measured through a secondary electron image or a reflection electron image with an application voltage of 1 kV and a magnification of 50000 times. For one particle, the thickness is measured at any multiple positions (for example, four points), and an average of the thickness measured by performing this operation for 10 particles can be regarded as the thickness of the coating layer 111.

The coating layer 111 may uniformly coat the active material 110.

The coating layer 111 may partially coat the surface of the active material 110. Particles of the active material 110 come into direct contact with each other via the parts not coated with the coating layer 111, thereby improving the electronic conductivity between the particles of the active material 110. Consequently, the battery can operate at high output.

The active material 110 and the coating layer 111 will be described in more detail. Coating Layer 111

The coating layer 111 coats at least part of the surface of the active material 110. The thickness of the coating layer 111 is greater than 0 nm and less than or equal to 75 nm.

The thickness of the coating layer 111 may be greater than or equal to 5 nm and less than or equal to 47 nm. The above can further reduce electronic resistance and can reduce the interfacial resistance of the battery.

The coating layer 111 contains the first solid electrolyte. The first solid electrolyte contains Li, M1, O, and X1. M1 is at least one selected from the group consisting of Ta and Nb. X1 is at least one selected from the group consisting of F, Cl, Br, and I.

The coating layer 111 may contain the first solid electrolyte as a main component or contain only the first solid electrolyte. The “main component” means a component contained most in terms of mass ratio. “Contains only the first solid electrolyte” means that materials other than the first solid electrolyte, except incidental impurities, are not intentionally added. For example, raw materials of the first solid electrolyte, byproducts produced when the first solid electrolyte is produced, and the like are included in the incidental impurities. The mass ratio of the incidental impurities to the entire mass of the coating layer 111 may be less than or equal to 5%, less than or equal to 3%, less than or equal to 1%, or less than or equal to 0.5%.

To further increase lithium ion conductivity, the first solid electrolyte may consist essentially of Li, M1, O, and X1. Here, “the first solid electrolyte consists essentially of Li, M1, O, and X1” means that the molar ratio of the total of the amounts of substance of Li, M1, O, and X1 to the total of the amounts of substance of all the elements constituting the first solid electrolyte is greater than or equal to 90%. As an example, the molar ratio may be greater than or equal to 95%.

To further increase lithium ion conductivity, the first solid electrolyte may contain a crystal phase in which a peak is present in a range of a diffraction angle 2θ of greater than or equal to 11.05° and less than or equal to 13.86° in an X-ray diffraction pattern obtained by X-ray diffraction measurement using the Cu-Kα line.

Here, the “peak” means a diffraction peak in the X-ray diffraction pattern.

The X-ray diffraction pattern of the first solid electrolyte according to the first embodiment can be acquired by X-ray diffraction measurement by the θ-2θ method using the Cu-Kα line (wavelengths of 1.5405 Å and 1.5444 Å, that is, wavelengths of 0.15405 nm and 0.15444 nm).

A molar ratio Li/M1 of Li to M1 is greater than or equal to 0.60 and less than or equal to 2.4 and a molar ratio O/X1 of O to X1 is greater than or equal to 0.16 and less than or equal to 0.35. This increases lithium ion conductivity.

The molar ratio Li/M1 is calculated by the numerical expression: (the amount of substance of Li)/(the total of the amounts of substance of Ta and Nb). The molar ratio O/X1 is calculated by the numerical expression: (the amount of substance of O)/(the total of the amounts of substance of F, Cl, Br, and I).

To further increase lithium ion conductivity, the molar ratio Li/M1 may be greater than or equal to 0.96 and less than or equal to 1.20.

X1 may be at least one selected from the group consisting of Cl, Br, and I. X1 may be Cl. A molar ratio O/Cl of O to Cl may be greater than or equal to 0.16 and less than or equal to 0.35. The molar ratio Li/M1 of Li to M1 may be greater than or equal to 0.60 and less than or equal to 2.4 and the molar ratio O/Cl of O to Cl may be greater than or equal to 0.16 and less than or equal to 0.35.

### Active Material 110

The active material 110 may be a positive electrode active material.

The positive electrode active material contains a material having characteristics of occluding and releasing metal ions (for example, lithium ions). Examples of the positive electrode active material include lithium-containing transition metal oxides, transition metal fluorides, polyanion materials, fluorinated polyanion materials, transition metal sulfides, transition metal oxysulfides, and transition metal oxynitrides. Examples of the lithium-containing transition metal oxides include Li(NiCoAl)O₂, Li(NiCoMn)O₂, and LiCoO₂. When a lithium-containing transition metal oxide is used as the positive electrode active material in particular, production costs can be reduced, and average discharge voltage can be increased.

The positive electrode active material may be a composite oxide containing Ni and Co. The positive electrode active material having such a configuration can improve the energy density and the charge-discharge efficiency of the battery.

The active material 110 may include a reaction inhibition layer containing an oxide. The coating layer 111 may cover at least part of the surface of the active material 110 including the reaction inhibition layer containing an oxide.

The reaction inhibition layer may contain Li—Nb—O compounds such as LiNbO₃, Li—B—O compounds such as LiBO₂ and Li₃BO₃, Li—Al—O compounds such as LiAlO₂, Li—Si—O compounds such as Li₄SiO₄, Li—S—O compounds such as Li₂SO₄, Li—Ti—O compounds such as Li₄Ti₅O₁₂, Li—Zr—O compounds such as Li₂ZrO₃, Li—Mo—O compounds such as Li₂MoO₃, Li-V-O compounds such as LiV₂O₅, Li—W—O compounds such as Li₂WO₄, or Li—P—O compounds such as Li₃PO₄.

The above configuration can inhibit oxidation of the first solid electrolyte contained in the coating layer 111.

### Method for Producing First Solid Electrolyte

The first solid electrolyte contained in the coating layer 111 can be produced by, for example, the following method.

Raw material powders are prepared and mixed together so as to have a desired composition. Examples of the raw material powders include oxides, hydroxides, halides, and acid halides.

As an example, when the first solid electrolyte contains Li, Ta, O, and Cl, Li₂O₂ and TaCl₅ are mixed together as the raw material powders at a Li₂O₂:TaCl₅ molar ratio of 1:2.

A mixture of the raw material powders is reacted with each other mechanochemically in a mixing device such as a planetary ball mill to obtain a reaction product. This method is often called mechanochemical milling. The reaction product may be heat-treated in a vacuum or an inert atmosphere. Alternatively, the mixture may be heat-treated in a vacuum or an inert gas atmosphere to obtain a reaction product. By these methods, the first solid electrolyte in the coated active material 130 according to the first embodiment is obtained. The inert atmosphere is, for example, an argon atmosphere or a nitrogen atmosphere.

Selection of the raw material powders, the mixing ratio of the raw material powders, and reaction conditions can adjust the position of a peak, that is, the configuration of a crystal phase of the first solid electrolyte in the coated active material 130 according to the first embodiment to a desired one.

The composition of the first solid electrolyte can be determined by, for example, inductively coupled plasma atomic emission spectroscopy or ion chromatography. For example, the composition of Li and M1 can be determined by inductively coupled plasma atomic emission spectroscopy, and the composition of X1 can be determined by ion chromatography.

### Method for Producing Coated Active Material

The coated active material 130 can be produced by, for example, the following method.

A powder of the active material 110 and a powder of the first solid electrolyte are prepared at a certain mass ratio. For example, a powder of Li(NiCoAl)O₂ as the active material 110 and a powder of LiTaOCl₄ as the first solid electrolyte are prepared. These two materials are charged into the same reaction vessel, and shear force is applied to the two materials using a rotating blade. Alternatively, the two materials may be caused to collide with each other through a jet airflow. By applying mechanical energy, at least part of the surface of the positive electrode active material can be coated with the first solid electrolyte.

Before applying mechanical energy to the mixture of the powder of the active material 110 and the powder of the first solid electrolyte, the mixture may be subjected to milling processing. For the milling processing, a mixing device such as a ball mill can be used. To inhibit oxidation of the materials, the milling processing may be performed in a dry atmosphere and an inert atmosphere.

The coated active material 130 may be produced by a dry particle composing method. Processing by the dry particle composing method includes applying at least one type of mechanical energy selected from the group consisting of impact, compression, and shear to the active material 110 and the first solid electrolyte. The active material 110 and the first solid electrolyte are mixed together at an appropriate ratio.

The apparatus for use in the method for producing the coated active material 130 is not particularly limited and can be an apparatus that can apply mechanical energy including impact, compression, and shear to the mixture of the active material 110 and the first solid electrolyte. Examples of the apparatus that can apply mechanical energy include ball mills, jet mills, compression shear type processing apparatuses (particle composing apparatuses) such as “Mechano Fusion” (manufactured by Hosokawa Micron Corporation) and “Nobilta” (manufactured by Hosokawa Micron Corporation), and “Hybridization System” (high-speed airflow impact apparatus) (manufactured by Nara Machinery Co., Ltd.).

“Mechano Fusion” is a particle composing apparatus using a dry mechanical composing technique by applying strong mechanical energy to a plurality of different material particles. In Mechano Fusion, mechanical energy including compression, shear, and friction is applied to a powder raw material charged into between a rotating vessel and a press head to cause particle composing.

“Nobilta” is a particle composing apparatus using a dry mechanical composing technique as a developed particle composing technique in order to perform composing with nanoparticles as a raw material. Nobilta produces composite particles by applying mechanical energy including impact, compression, and shear to a plurality of raw material powders.

In “Nobilta,” in a horizontal cylindrical mixing vessel, a rotor disposed so as to have a certain gap with an inner wall of the mixing vessel rotates at high speed, and processing causing the raw material powders to forcedly pass through the gap is repeated a plurality of times. This exerts the force of impact, compression, and shear on the mixture, and composite particles of the active material 110 and the first solid electrolyte can be produced. Conditions such as the rotational speed of the rotor, a processing time, and charging amounts can be adjusted as appropriate.

In “Hybridization System,” while raw material powders are dispersed in a high-speed airflow, force mainly of impact is exerted thereon. This produces composite particles of the active material 110 and the first solid electrolyte.

### Second Embodiment

A second embodiment will be described below. Descriptions overlapping with those of the first embodiment described above will be omitted as appropriate.

FIG. 2 is a sectional view of a schematic configuration of a positive electrode material 1000 in the second embodiment.

The positive electrode material 1000 in the second embodiment contains the coated active material 130 in the first embodiment and a second solid electrolyte 100. The shape of the second solid electrolyte 100 is, for example, a particle shape. With the second solid electrolyte 100, ionic conductivity in the positive electrode material 1000 can be sufficiently ensured.

The active material 110 is separated from the second solid electrolyte 100 via the coating layer 111. The active material 110 may not be in direct contact with the second solid electrolyte 100. This is because the coating layer 111 has ionic conductivity. The coating layer 111 may uniformly coat the active material 110. The coating layer 111 inhibits direct contact between the active material 110 and the second solid electrolyte 100 to inhibit side reactions of the second solid electrolyte 100. Consequently, the charge-discharge efficiency of the battery improves, and an increase in the reaction overvoltage of the battery can be inhibited.

The second solid electrolyte 100 contains, for example, a material having lithium ion conductivity. For example, the second solid electrolyte 100 has high lithium ion conductivity. Here, high lithium ion conductivity is, for example, greater than or equal to 1×10⁻³ mS/cm. That is, the second solid electrolyte 100 contained in the positive electrode material 1000 in the second embodiment can have, for example, an ionic conductivity of greater than or equal to 1×10⁻³ mS/cm.

The second solid electrolyte 100 may be an oxyhalide solid electrolyte. By using the technique of the present disclosure, a higher effect can be obtained.

The oxyhalide solid electrolyte may have the same composition as the first solid electrolyte in the first embodiment. With the above configuration, the first solid electrolyte and the second solid electrolyte 100 are electrolyte materials having a similar crystal phase, and thus a good interface is formed between the first solid electrolyte and the second solid electrolyte 100. This can improve the charge-discharge efficiency of the battery.

The oxyhalide solid electrolyte may have a different composition from the first solid electrolyte in the first embodiment. That is, the second solid electrolyte 100 may be an oxyhalide solid electrolyte having a different composition from the first solid electrolyte. As described above, the coating layer 111 inhibits direct contact between the active material 110 and the second solid electrolyte 100 and inhibits side reactions of the second solid electrolyte 100. With the above configuration, a material having higher lithium ion conductivity can be used as the second solid electrolyte 100, and thus the characteristics of the battery can be improved. For example, the second solid electrolyte 100 may have higher lithium ion conductivity than the first solid electrolyte.

The oxyhalide solid electrolyte may contain Li, M1, M2, O, and X2, in which M2 may be at least one selected from the group consisting of Zr, Y, La, and Al, and X2 may be at least one selected from the group consisting of F, Cl, Br and I.

To further increase lithium ion conductivity, the second solid electrolyte 100 may consist essentially of Li, M1, M2, O, and X2. Here, “the second solid electrolyte 100 consists essentially of Li, M1, M2, O, and X2” means that the molar ratio of the total of amounts of substance of Li, M1, M2, O, and X2 to the total of amounts of substance of all the elements constituting the second solid electrolyte 100 is greater than or equal to 90%. As an example, the molar ratio may be greater than or equal to 95%.

To further increase lithium ion conductivity, the second solid electrolyte 100 may consist only of Li, M1, M2, O, and X2.

The oxyhalide solid electrolyte may contain a crystal phase having a peak in a range of a diffraction angle 2θ of greater than or equal to 11.08° and less than or equal to 15.63° in an X-ray diffraction pattern obtained by X-ray diffraction measurement using the Cu-Kα line. That is, the second solid electrolyte 100 may contain a crystal phase having a peak in a range of a diffraction angle 2θ of greater than or equal to 11.08° and less than or equal to 15.63° in an X-ray diffraction pattern obtained by X-ray diffraction measurement using the Cu-Kα line. The second solid electrolyte 100 having the above configuration has high lithium ion conductivity because it easily forms paths for lithium ions to diffuse.

The X-ray diffraction pattern of the second solid electrolyte 100 can be acquired by X-ray diffraction measurement by the θ-2θ method by using the Cu-Kα line (wavelengths of 1.5405 Å and 1.5444 Å, that is, wavelengths of 0.15405 nm and 0.15444 nm).

X2 may be at least one selected from the group consisting of F, Cl, and Br. X2 may be at least one selected from the group consisting of Cl and Br.

In the second solid electrolyte 100, the molar ratio of M2 to the total of M1 and M2 may be greater than zero and less than or equal to 0.60.

The molar ratio of M2 to the total of M1 and M2 is calculated by the numerical expression (the amount of substance of M2)/(the amount of substance of M1+the amount of substance of M2). Hereinafter, the molar ratio of M2 to the total of M1 and M2 will also be called the “M2/(M1+M2) molar ratio.”

To increase the electrochemical stability of the second solid electrolyte 100, the molar ratio of F to X2 may be greater than or equal to zero and less than or equal to 0.50.

The molar ratio of F to X2 is also called the “F/X2 molar ratio.” The molar ratio of F to X2 is calculated by the numerical expression: (the amount of substance of F)/(the total of the amounts of substance of F, Cl, Br, and I).

The shape of the second solid electrolyte 100 is not particularly limited. When the second solid electrolyte 100 is powder, its shape may be, for example, a needle shape, a spherical shape, an elliptic spherical shape, or the like. For example, the shape the second solid electrolyte 100 may be a particle shape.

For example, when the shape of the second solid electrolyte 100 is a particle shape, (for example, a spherical shape), its median diameter may be less than or equal to 100 μm. When the median diameter is less than or equal to 100 μm, the coated active material 130 and the second solid electrolyte 100 can form a good dispersed state in the positive electrode material 1000. Thus, the charge-discharge characteristics of the battery improve. In the second embodiment, the median diameter of the second solid electrolyte 100 may be less than or equal to 10 μm.

With the above configuration, in the positive electrode material 1000, the coated active material 130 and the second solid electrolyte 100 can form a good dispersed state.

In the second embodiment, the median diameter of the second solid electrolyte 100 may be smaller than the median diameter of the coated active material 130.

With the above configuration, in the positive electrode material 1000, the second solid electrolyte 100 and the coated active material 130 can form a better dispersed state.

The median diameter of the coated active material 130 may be greater than or equal to 0.1 μm and less than or equal to 100 μm.

When the median diameter of the coated active material 130 is greater than or equal to 0.1 μm, in the positive electrode material 1000, the coated active material 130 and the second solid electrolyte 100 can form a good dispersed state. Consequently, the charge-discharge characteristics of the battery improve.

When the median diameter of the coated active material 130 is less than or equal to 100 μm, the diffusion rate of lithium inside the coated active material 130 is sufficiently ensured. Thus, the battery can operate at high output.

The median diameter of the coated active material 130 may be larger than the median diameter of the second solid electrolyte 100. With this, the coated active material 130 and the second solid electrolyte 100 can form a good dispersed state.

Here, the median diameter means a particle diameter when a cumulative volume in volume-based particle size distribution is equal to 50%. The volume-based particle size distribution is measured by, for example, a laser diffraction type measurement apparatus or an image analysis apparatus.

In the positive electrode material 1000 in the second embodiment, the second solid electrolyte 100 and the coated active material 130 may be in contact with each other as illustrated in FIG. 2. In this case, the coating layer 111 and the active material 110 are in contact with each other.

The positive electrode material 1000 in the second embodiment may contain a plurality of particles of the second solid electrolyte 100 and a plurality of particles of the coated active material 130.

In the positive electrode material 1000 in the second embodiment, the content of the second solid electrolyte 100 and the content of the coated active material 130 may be the same as each other or different from each other.

The above configuration can inhibit an increase in the internal resistance of the battery during charging.

The composition of the second solid electrolyte 100 can be determined by, for example, inductively coupled plasma atomic emission spectroscopy or ion chromatography. For example, the composition of Li, M1, and M2 can be determined by inductively coupled plasma atomic emission spectroscopy, and the composition of X2 can be determined by ion chromatography.

### Method for Producing Positive Electrode Material

By mixing together the coated active material 130 and the second solid electrolyte 100, the positive electrode material 1000 is obtained. The method for mixing together the coated active material 130 and the second solid electrolyte 100 is not particularly limited. For example, the coated active material 130 and the second solid electrolyte 100 may be mixed together using a tool such as a mortar, or the coated active material 130 and the second solid electrolyte 100 may be mixed together using a mixing device such as a ball mill. The mixing ratio between the coated active material 130 and the second solid electrolyte 100 is not particularly limited.

### Third Embodiment

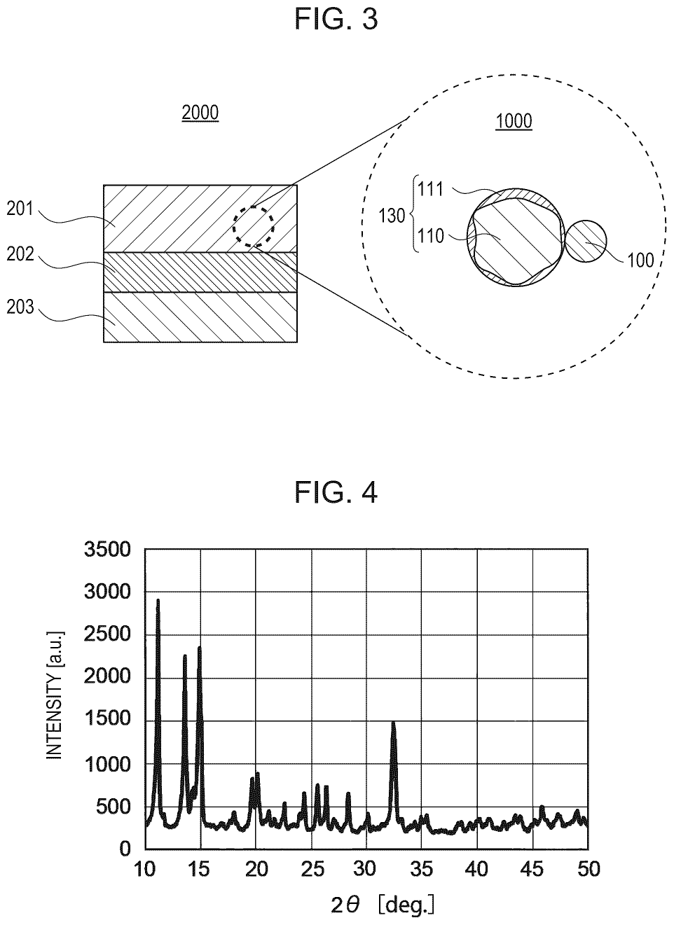

FIG. 3 is a sectional view of a schematic configuration of a battery 2000 in a third embodiment.

The battery 2000 in the third embodiment includes a positive electrode 201, an electrolyte layer 202, and a negative electrode 203. The positive electrode 201 contains the positive electrode material in the second embodiment described above (for example, the positive electrode material 1000). The electrolyte layer 202 is disposed between the positive electrode 201 and the negative electrode 203. The above configuration can improve the initial efficiency of the battery 2000.

As to the volume ratio “v1:100−v1” between the coated active material 130 and the second solid electrolyte 100 contained in the positive electrode 201, 30≤v1≤98 may be satisfied. Here, v1 represents the volume ratio of the coated active material 130 when the total volume of the coated active material 130 and the second solid electrolyte 100 contained in the positive electrode 201 is 100. When 30≤v1 is satisfied, sufficient battery energy density can be ensured. When v1≤98 is satisfied, the battery 2000 operates at high output more easily.

The thickness of the positive electrode 201 may be greater than or equal to 10 μm and less than or equal to 500 μm. When the thickness of the positive electrode 201 is greater than or equal to 10 μm, the energy density of the battery 2000 can be sufficiently ensured. When the thickness of the positive electrode 201 is less than or equal to 500 μm, operation at high output is enabled.

The electrolyte layer 202 is a layer containing an electrolyte. The electrolyte is, for example, a solid electrolyte. The solid electrolyte contained in the electrolyte layer 202 is called a third solid electrolyte. That is, the electrolyte layer 202 may contain the third solid electrolyte. The electrolyte layer 202 may be a solid electrolyte layer.

The third solid electrolyte may be an oxyhalide solid electrolyte. As the third solid electrolyte, a solid electrolyte having the same composition or the same crystal phase as the first solid electrolyte in the first embodiment or a solid electrolyte having the same composition or the same crystal phase as the second solid electrolyte 100 in the second embodiment may be used. That is, the electrolyte layer 202 may contain a solid electrolyte having the same composition or the same crystal phase as the first solid electrolyte in the first embodiment or a solid electrolyte having the same composition or containing the same crystal phase as the second solid electrolyte 100 in the second embodiment.

The third solid electrolyte may be an oxyhalide solid electrolyte having a different composition from the first solid electrolyte or an oxyhalide solid electrolyte having a different composition from the second solid electrolyte 100. That is, the electrolyte layer 202 may contain an oxyhalide solid electrolyte having a different composition from the first solid electrolyte and contain an oxyhalide solid electrolyte containing a different composition or different crystal phase from the second solid electrolyte 100.

The third solid electrolyte may be a halide solid electrolyte.

The difference between the halide solid electrolyte and the oxyhalide solid electrolyte is whether oxygen is intentionally contained or not.

When the third solid electrolyte is the halide solid electrolyte, examples of the halide solid electrolyte include Li₃YX′₆, Li₂MgX′₄, Li₂FeX′₄, Li(Al,Ga,In)X′₄, and Li₃ (Al,Ga,In)X′₆. Here, X′ is at least one selected from the group consisting of Cl and Br.

The third solid electrolyte may be a sulfide solid electrolyte, an oxide solid electrolyte, a polymeric solid electrolyte, or a complex hydride solid electrolyte.

When the third solid electrolyte is the sulfide solid electrolyte, examples of the sulfide solid electrolyte include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂. To these, LiX, Li₂O, MO_{q}, LiₚMO_{q}, or the like may be added. The element X in “LiX” is at least one element selected from the group consisting of F, Cl, Br, and I. The element M in “MO_{q}” and “LiₚMO_{q}” is at least one element selected from the group consisting of P, Si, Ge, B, Al, Ga, In, Fe, and Zn. The letters p and q in “MO_{q}” and “LiₚMO_{q}” are each an independent natural number.

With the above configuration, the electrolyte layer 202 contains the sulfide solid electrolyte, which has excellent reduction stability, and thus a negative electrode material with low potential, such as graphite or metallic lithium, can be used, and the energy density of the battery 2000 can be improved.

When the third solid electrolyte is the oxide solid electrolyte, examples of the oxide solid electrolyte include NASICON type solid electrolytes represented by LiTi₂(PO₄)₃ and element-substituted products thereof, (LaLi) TiO₃-based perovskite type solid electrolytes, LISICON type solid electrolytes represented by Li₁₄ZnGe₄O₁₆, Li₄SiO₄, and LiGeO₄ and element-substituted products thereof, garnet type solid electrolytes represented by Li₇La₃Zr₂O₁₂ and element-substituted products thereof, Li₃N and a H-substituted product thereof, Li₃PO₄ and a N-substituted product thereof, and glasses or glass ceramics with Li—B—O compounds such as LiBO₂ and Li₃BO₃ as base materials and with materials such as Li₂SO₄ and Li₂CO₃ added.

When the third solid electrolyte is the polymeric solid electrolyte, examples of the polymeric solid electrolyte include compounds of a polymer compound and a lithium salt. The polymer compound may have an ethylene oxide structure. When having the ethylene oxide structure, the polymer compound can contain the lithium salt in a large amount. Thus, ionic conductivity can be further increased. Examples of the lithium salt include LiPF₆, LiBF₄, LiSbF₆, LiAsF₆, LiSO₃CF₃, LIN (SO₂CF₃)₂, LIN (SO₂C₂F₅)₂, LiN(SO₂CF₃)(SO₂C₄F₉), and LiC(SO₂CF₃)₃. As the lithium salt, one lithium salt selected from these may be used alone or a mixture of two or more lithium salts selected from these may be used.

When the third solid electrolyte is the complex hydride solid electrolyte, examples of the complex hydride solid electrolyte include LiBH₄—LiI and LiBH₄—P₂S₅.

The electrolyte layer 202 may contain the third solid electrolyte as a main component. That is, the electrolyte layer 202 may contain the third solid electrolyte in an amount of, for example, greater than or equal to 50% in terms of mass ratio with respect to the entire electrolyte layer 202 (that is, greater than or equal to 50% by mass).

The above configuration can further improve the charge-discharge characteristics of the battery 2000.

The electrolyte layer 202 may contain the third solid electrolyte in an amount of greater than or equal to 70% in terms of mass ratio with respect to the entire electrolyte layer 202 (that is, greater than or equal to 70% by mass).

The above configuration can further improve the charge-discharge characteristics of the battery 2000.

The electrolyte layer 202 may further contain incidental impurities or starting materials used when the third solid electrolyte is synthesized, byproducts and decomposed products, or the like while containing the third solid electrolyte as the main component.

The electrolyte layer 202 may contain the third solid electrolyte in an amount of, for example, 100% in terms of mass ratio with respect to the entire electrolyte layer 202 except impurities incidentally mixed in (that is, 100% by mass).

The above configuration can further improve the charge-discharge characteristics of the battery 2000.

As described above, the electrolyte layer 202 may consist only of the third solid electrolyte.

Note that the electrolyte layer 202 may contain two or more of the materials exemplified as the third solid electrolyte. For example, the electrolyte layer 202 may contain the halide solid electrolyte and the sulfide solid electrolyte.

The thickness of the electrolyte layer 202 may be greater than or equal to 1 μm and less than or equal to 300 μm. When the thickness of the electrolyte layer 202 is greater than or equal to 1 μm, the positive electrode 201 and the negative electrode 203 can be separated from each other more surely. When the thickness of the electrolyte layer 202 is less than or equal to 300 μm, operation at high output can be achieved.

The negative electrode 203 contains a material having characteristics of occluding and releasing metal ions (for example, lithium ions). The negative electrode 203 contains, for example, a negative electrode active material.

Examples of the negative electrode active material include metallic materials, carbon materials, oxides, nitrides, tin compounds, and silicon compounds. The metallic material may be an elemental metal. Alternatively, the metallic material may be an alloy. Examples of the metallic material include lithium metal and lithium alloys. Examples of the carbon material include natural graphite, coke, graphitizing carbon, carbon fiber, spherical carbon, artificial graphite, and amorphous carbon. From the viewpoint of capacity density, silicon (Si), tin (Sn), silicon compounds, and tin compounds can be used.

The negative electrode 203 may contain a solid electrolyte material. As the solid electrolyte material, the solid electrolyte materials exemplified as the material constituting the electrolyte layer 202 may be used. The above configuration improves lithium ion conductivity inside the negative electrode 203 and enables operation at high output.

The median diameter of negative electrode active material particles may be greater than or equal to 0.1 μm and less than or equal to 100 μm. When the median diameter of the negative electrode active material particles is greater than or equal to 0.1 μm, in the negative electrode, the negative electrode active material particles and the solid electrolyte material can form a good dispersed state. This improves the charge-discharge characteristics of the battery. When the median diameter of the negative electrode active material particles is less than or equal to 100 μm, lithium diffusion within the negative electrode active material particles becomes fast. Thus, the battery can operate at high output.

The median diameter of the negative electrode active material particles may be larger than the median diameter of the solid electrolyte material. This can form a good dispersed state of the negative electrode active material particles and the solid electrolyte material.

As to the volume ratio “v2:100−v2” between the negative electrode active material particles and the solid electrolyte material contained in the negative electrode 203, 30≤v2≤95 may be satisfied. When 30≤v2, sufficient battery energy density can be ensured. When v2≤95, operation at high output can be achieved.

The thickness of the negative electrode 203 may be greater than or equal to 10 μm and less than or equal to 500 μm. When the thickness of the negative electrode 203 is greater than or equal to 10 μm, sufficient battery energy density can be ensured. When the thickness of the negative electrode 203 is less than or equal to 500 μm, operation at high output can be achieved.

At least one selected from the positive electrode 201, the electrolyte layer 202, and the negative electrode 203 may contain a binder for the purpose of improving adhesion among particles. The binder is used in order to improve the binding properties of the materials constituting the electrodes. Examples of the binder include polyvinylidene fluoride, polytetrafluoroethylene, polyethylene, polypropylene, aramid resins, polyamide, polyimide, polyamideimide, polyacrylonitrile, polyacrylic acid, polymethylacrylate, polyethylacrylate, polyhexylacrylate, polymethacrylic acid, polymethylmethacrylate, polyethylmethacrylate, polyhexylmethacrylate, polyvinyl acetate, polyvinyl pyrrolidone, polyether, polyethersulfone, hexafluoropolypropylene, styrene-butadiene rubber, and carboxymethylcellulose. Examples of the binder also include copolymers of two or more materials selected from the group consisting of tetrafluoroethylene, hexafluoroethylene, hexafluoropropylene, perfluoroalkyl vinyl ethers, vinylidene fluoride, chlorotrifluoroethylene, ethylene, propylene, pentafluoropropylene, fluoromethyl vinyl ether, acrylic acid, and hexadiene. In addition, two or more selected from these may be mixed together to be used as the binder.

At least one selected from the positive electrode 201 and the negative electrode 203 may contain a conductive aid for the purpose of increasing electronic conductivity. Examples of the conductive aid include graphites such as natural graphite and artificial graphite, carbon blacks such as acetylene black, and ketjen black, conductive fibers such as carbon fibers and metallic fibers, carbon fluoride, metallic powders such as aluminum, conductive whiskers such as zinc oxide and potassium titanate, conductive metal oxides such as titanium oxide, and conductive polymer compounds such as polyaniline, polypyrrole, and polythiophene. When a carbon conductive aid is used, cost reduction can be achieved.

The battery in the third embodiment can be configured as a battery of various shapes such as a coin shape, a cylindrical shape, a rectangular shape, a sheet shape, a button shape, a flat shape, and a laminated shape.

### OTHER EMBODIMENTS

### Note

The following techniques are disclosed by the description of the above embodiments.

### Technique 1

A coated active material comprising:
an active material; and
a coating layer comprising a first solid electrolyte and coating at least part of a surface of the active material, in which
the first solid electrolyte comprises Li, M1, O, and X1,
M1 is at least one selected from the group consisting of Ta and Nb,
X1 is at least one selected from the group consisting of F, Cl, Br, and I,
a thickness of the coating layer is greater than 0 nm and less than or equal to 75 nm,
a molar ratio Li/M1 of Li to M1 is greater than or equal to 0.60 and less than or equal to 2.4, and
a molar ratio O/X1 of O to X1 is greater than or equal to 0.16 and less than or equal to 0.35.

With this configuration, lithium ion transfer in the active material interface is facilitated. In addition, by setting the thickness of the coating layer to less than or equal to 75 nm, the contact between the active materials improves, and electronic resistance can be reduced. Thus, the interfacial resistance of the battery can be reduced. In addition, with this configuration, a crystal phase having high lithium ion conductivity is easily formed in the first solid electrolyte, and thus the first solid electrolyte has higher lithium ion conductivity. Thus, the coated active material of Technique 1 can improve the characteristics of the battery.

### Technique 2

The coated active material according to Technique 1, in which the thickness is greater than or equal to 5 nm and less than or equal to 47 nm. With this configuration, lithium ion transfer in the active material interface is facilitated. In addition, by setting the thickness of the coating layer to greater than or equal to 5 nm and less than or equal to 47 nm, the contact between the active materials improves, and electronic resistance can be reduced. Thus, the coated active material of Technique 2 can reduce the interfacial resistance of the battery.

### Technique 3

The coated active material according to Technique 1 or 2, in which the first solid electrolyte comprises a crystal phase in which a peak is present in a range of a diffraction angle 2θ of greater than or equal to 11.05° and less than or equal to 13.86° in an X-ray diffraction pattern obtained by X-ray diffraction measurement using the Cu-Kα line. With this configuration, paths for lithium ions to diffuse are easily formed in the first solid electrolyte, and thus the first solid electrolyte has high lithium ion conductivity. Thus, the coated active material of Technique 3 can improve the characteristics of the battery.

### Technique 4

The coated active material according to Technique 1, in which the molar ratio Li/M1 is greater than or equal to 0.96 and less than or equal to 1.20. With this configuration, the crystal phase having high lithium ion conductivity is more easily formed in the first solid electrolyte, and thus the first solid electrolyte has higher lithium ion conductivity. Thus, the coated active material of Technique 4 can improve the characteristics of the battery.

### Technique 5

The coated active material according to any one of Techniques 1 to 4, in which X1 is Cl. The coated active material of Technique 5 can improve the characteristics of the battery.

### Technique 6

The coated active material according to any one of Techniques 1 to 5, in which the active material is a positive electrode active material. This configuration can improve the energy density and the charge-discharge efficiency of the battery.

### Technique 7

The coated active material according to Technique 6, in which the positive electrode active material is a composite oxide comprising Ni and Co. This configuration can improve the energy density and the charge-discharge efficiency of the battery.

### Technique 8

The coated active material according to Technique 6 or 7, in which the positive electrode active material includes a reaction inhibition layer consisting of an oxide. This configuration can inhibit oxidation of the first solid electrolyte contained in the coating layer. Thus, the coated active material of Technique 7 can improve the characteristics of the battery.

### Technique 9

A positive electrode material comprising:
the coated active material according to any one of Techniques 6 to 8; and
a second solid electrolyte.

This configuration can reduce the interfacial resistance of the battery.

### Technique 10

The positive electrode material according to Technique 9, in which the second solid electrolyte is an oxyhalide solid electrolyte. This configuration can improve the charge-discharge efficiency of the battery.

### Technique 11

The positive electrode material according to Technique 10, in which the oxyhalide solid electrolyte has the same composition as the first solid electrolyte. This configuration forms a good interface between the first solid electrolyte and the second solid electrolyte. Thus, the charge-discharge efficiency of the battery can be improved.

### Technique 12

The positive electrode material according to Technique 10, in which the oxyhalide solid electrolyte has a different composition from the first solid electrolyte. With this configuration, a material having higher lithium ion conductivity can be used as the second solid electrolyte. Thus, the characteristics of the battery can be improved.

### Technique 13

The positive electrode material according to any one of Techniques 10 to 12, in which the oxyhalide solid electrolyte comprises Li, M1, M2, O, and X2, M2 is at least one selected from the group consisting of Zr, Y, La, and Al, and X2 is at least one selected from the group consisting of F, Cl, Br, and I. Paths for lithium ions to diffuse are easily formed in the second solid electrolyte, and thus the second solid electrolyte has high lithium ion conductivity. Thus, the characteristics of the battery can be improved.

### Technique 14

The positive electrode material according to any one of Techniques 10 to 13, in which the oxyhalide solid electrolyte comprises a crystal phase having a peak in a range of a diffraction angle 2θ of greater than or equal to 11.08° and less than or equal to 15.63° in an X-ray diffraction pattern obtained by X-ray diffraction measurement using the Cu-Kα line. With this configuration, the second solid electrolyte has high lithium ion conductivity, which can thus improve the characteristics of the battery.

### Technique 15

The positive electrode material according to Technique 13, in which X2 is at least one selected from the group consisting of Cl and Br. This configuration can increase the ionic conductivity of the second solid electrolyte and can thus improve the characteristics of the battery.

### Technique 16

The positive electrode material according to Technique 13 or 15, in which a molar ratio of M2 to a total of M1 and M2 is greater than zero and less than or equal to 0.60. With this configuration, the electrochemical stability of the second solid electrolyte can be increased, which can thus improve the characteristics of the battery.

### Technique 17

The positive electrode material according to any one of Techniques 13, 15, and 16, in which a molar ratio of F to X2 is greater than or equal to zero and less than or equal to 0.50. With this configuration, the ionic conductivity of the second solid electrolyte can be increased, which can thus improve the characteristics of the battery.

### Technique 18

A battery comprising:
a positive electrode comprising the positive electrode material according to any one of Techniques 9 to 17;
a negative electrode; and
an electrolyte layer disposed between the positive electrode and the negative electrode.

By using the positive electrode material containing the coated active material of the present disclosure for the positive electrode, initial efficiency can be improved.

### EXAMPLES

The details of the present disclosure will be described below using examples and a comparative example.

### Example 1

### Production of First Solid Electrolyte and Second Solid Electrolyte

In an argon atmosphere with a dew point of lower than or equal to −60° C., Li₂O₂ and TaCl₅ as raw material powders were weighted so as to be Li₂O₂:TaCl₅=1:2 in terms of molar ratio. Subsequently, using a planetary ball mill (manufactured by Fritsch GmbH, Type P-7), the obtained mixture was subjected to milling processing on the conditions of 12 hours and 600 rpm. Furthermore, it was subjected to processing at 200° C. for 3 hours to obtain a powder of the first solid electrolyte and the second solid electrolyte according to Example 1 containing Li, Ta, O, and Cl. That is, the first solid electrolyte and the second solid electrolyte were materials having the same composition.

It was confirmed by a preliminary experiment that the measured value of the composition of the obtained solid electrolyte was substantially the same as a charging ratio, and thus here the composition of the obtained solid electrolyte is shown in terms of the charging ratio. The first solid electrolyte according to Example 1 had a molar ratio Li/Ta of Li to Ta of 1.0 and a molar ratio O/Cl of O to Cl of 0.22.

In a dry environment having a dew point of lower than or equal to −50° C., an X-ray diffraction pattern of the first solid electrolyte according to Example 1 was measured by the θ-2θ method using an X-ray diffraction apparatus (Rigaku Corporation, MiniFlex 600). As an X-ray source, the Cu-Kα line (wavelengths of 1.5405 Å and 1.5444 Å) was used. FIG. 4 is a graph of the X-ray diffraction pattern of the first solid electrolyte. For the first solid electrolyte, peaks were found in a range of a diffraction angle 2θ of greater than or equal to 11.05° and less than or equal to 13.86°. The second solid electrolyte was the material produced in the same manner as for the first solid electrolyte and having the same composition and thus showed a similar X-ray diffraction pattern.

### Production of Coated Active Material

In an argon atmosphere with a dew point of lower than or equal to −60° C., Li(NiCoAl)O₂ (hereinafter, referred to as NCA) as a positive electrode active material and the first solid electrolyte according to Example 1 were weighed so as to have a volume ratio of 100:1. These materials were charged into a dry particle composing apparatus Nobilta (manufactured by Hosokawa Micron Corporation), and composing processing on the conditions of 3000 rpm and 60 minutes was performed to form a coating layer containing the first solid electrolyte on the surfaces of particles of the positive electrode active material. Thus, a coated active material according to Example 1 was produced.

### Production of Positive Electrode Material

In an argon atmosphere with a dew point of lower than or equal to −60° C., the coated active material and the second solid electrolyte according to Example 1 were weighed so as to have a mass ratio of the coated active material:the second solid electrolyte=77.68:24.32. These materials were mixed together with a mortar to produce a positive electrode material according to Example 1.

### Example 2

### Production of Coated Active Material

A coated active material according to Example 2 was produced in the same manner as in Example 1 except that the volume ratio between NCA and the first solid electrolyte was set to NCA: the first solid electrolyte=100:5.

### Production of Positive Electrode Material

In an argon atmosphere having a dew point of lower than or equal to −60° C., the coated active material and the second solid electrolyte according to Example 2 were weighed so as to have a mass ratio of the coated active material:the second solid electrolyte=78.12:21.88. These materials were mixed together with a mortar to produce a positive electrode material according to Example 2.

### Example 3

### Production of Coated Active Material

A coated active material according to Example 3 was produced in the same manner as in Example 1 except that the volume ratio between NCA and the first solid electrolyte was set to NCA: the first solid electrolyte=100:10.

### Production of Positive Electrode Material

In an argon atmosphere with a dew point of lower than or equal to −60° C., the coated active material and the second solid electrolyte according to Example 3 were weighed so as to have a mass ratio of the coated active material:the second solid electrolyte=81.45:18.55. These materials were mixed together with a mortar to produce a positive electrode material according to Example 3.

### Comparative Example 1

In Comparative Example 1, production of the coating layer in the positive electrode active material was not performed. That is, NCA without the coating layer formed and the second solid electrolyte were weighed so as to be NCA: the second solid electrolyte=74.91:25.09, and these materials were mixed together with a mortar to produce a positive electrode material of Comparative Example 1.

### Cross Section SEM Measurement of Thickness of Coating Layer

Using the coated active materials of Examples 1 to 3 described above, the thickness of the coating layer was measured. The coated active material and a metallic powder were mixed together to be pelletized, which was subjected to cross section processing by ion milling. The thickness of the coating layer was measured at any multiple positions (four points) for one particle with a SEM. This was performed for 10 particles, and an average of the measured thickness was regarded as the thickness of the coating layer. The thickness measurement was performed from a secondary electron image with an application voltage of 1 kV and a magnification of 50000 times.

### Production of Battery

Using the positive electrode materials of Examples 1 to 3 and Comparative Example 1 described above, the following step was performed.

First, in an insulating outer tube, 60 mg of Li₂S—P₂S₅ and 20 mg of Li₃Y₁Br₂Cl₄, and the positive electrode material were stacked on each other in this order. In this process, the mass of the positive electrode material was weighed such that the mass of the positive electrode active material was 10.35 mg. This was press-molded at a pressure of 720 MPa to obtain a positive electrode and a solid electrolyte layer.

Next, metallic Li (thickness: 200 μm) was stacked on the side of the solid electrolyte layer opposite to the side in contact with the positive electrode. This was press-molded at a pressure of 80 MPa to obtain a stacked body including the positive electrode, the solid electrolyte layer, and a negative electrode.

Next, stainless steel current collectors were disposed on the top and the bottom of the stacked body, and current collector leads were attached to the current collectors.

Finally, using an insulating ferrule, the inside of the insulating outer tube was insulated from the external atmosphere and hermetically sealed to produce a battery.

According to the above, batteries of Examples 1 to 3 and Comparative Example 1 described above were produced.

### Charging Test

Using each of the batteries of Examples 1 to 3 and Comparative Example 1 described above, a charging test was conducted on the following conditions.

The battery was placed in a thermostatic chamber at 25° C.

At a current value of 80 μA, which is 0.05 C rate (20 hours rate) with respect to the theoretical capacity of the battery, the battery was charged with a constant current until a voltage of 4.3 V and was rested for 30 minutes. Subsequently, at a current value of 80 μA, which is 0.05 C rate (20 hours rate), the battery was discharged with a constant current until a voltage of 2.5 V and was rested for 30 minutes.

Next, measurement was performed on the battery by the AC impedance method. The voltage amplitude was set to +10 mV, and the frequency was set to 10⁷ to 10⁻² Hz. For the measurement, an electrochemical measurement system manufactured by Solartron was used.

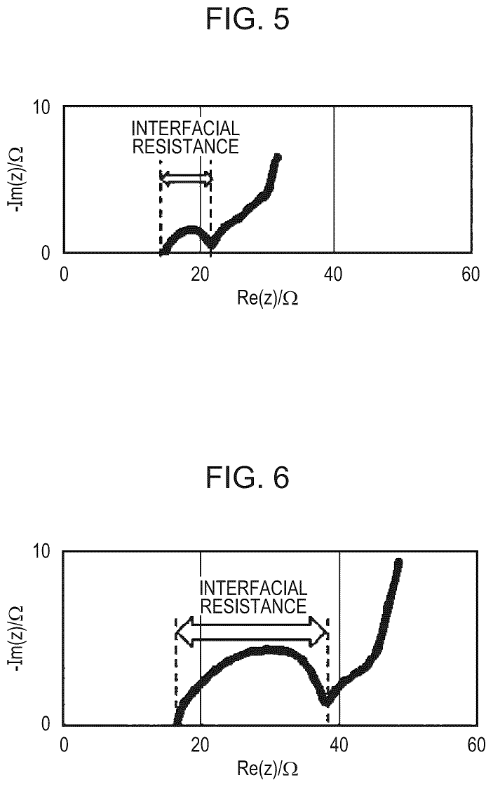

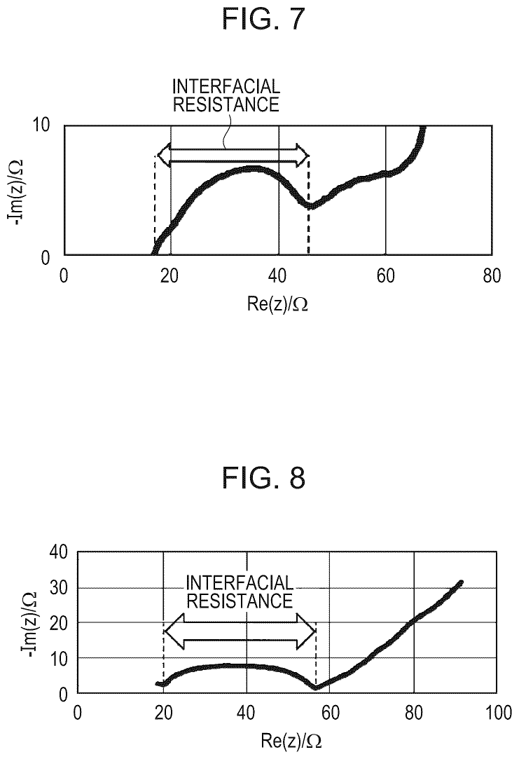

FIG. 5 is a Nyquist diagram of the battery in Example 1 at 3.85 V. FIG. 6 is a Nyquist diagram of the battery in Example 2 at 3.85 V. FIG. 7 is a Nyquist diagram of the battery in Example 3 at 3.85 V. FIG. 8 is a Nyquist diagram of the battery in Comparative Example 1 at 3.85 V. The horizontal axis and the vertical axis of FIG. 5 to FIG. 8 represent the real part of impedance and the imaginary part of impedance, respectively. The semi-arc waveform shown in the Nyquist diagram was attributed to a resistance component with the positive electrode and a resistance component with metallic Li as the negative electrode, and curve fitting analysis was performed to calculate an interfacial resistance value with the positive electrode for each of Examples 1 to 3 and Comparative Example 1.

Table 1 lists the respective ratios of the interfacial resistance values of Examples 1 to 3 when the interfacial resistance value of Comparative Example 1 is set to 100.

TABLE 1

| | Thickness | Addition amount of | Ratio of |
|---|---|---|---|
| | of coating | first solid electrolyte | interfacial |
| | layer (nm) | (vol %) | resistance (%) |
| Example 1 | 12.0 | 1 | 18.8 |
| Example 2 | 46.7 | 5 | 61.0 |
| Example 3 | 74.8 | 10 | 80.1 |
| Comparative | 0 | 0 | 100 |
| Example 1 | | | |

### Discussion

It can be seen from the results of Examples 1 to 3 and Comparative Example 1 listed in Table 1 that when the thickness of the coating layer is 12 nm, the resistance value is minimum, and as the thickness increases, the interfacial resistance increases. It is inferred that adhesion between the active material and the electrolyte was maintained by the coating, and the resistance of Li insertion and extraction reduced. Furthermore, by thin coating, the contact between the active materials and between the active material and the conductive aid improved, and consequently, the interfacial resistance reduced to a maximum of 18.8% compared to that of Comparative Example 1.

The battery of the present disclosure can be used as, for example, an all-solid lithium secondary battery or the like.

What is claimed is:

1. A coated active material comprising:
an active material; and
a coating layer comprising a first solid electrolyte and coating at least part of a surface of the active material, wherein
the first solid electrolyte comprises Li, M1, O, and X1,
M1 is at least one selected from the group consisting of Ta and Nb,
X1 is at least one selected from the group consisting of F, Cl, Br, and I,
a thickness of the coating layer is greater than 0 nm and less than or equal to 75 nm,
a molar ratio Li/M1 of Li to M1 is greater than or equal to 0.60 and less than or equal to 2.4, and
a molar ratio O/X1 of O to X1 is greater than or equal to 0.16 and less than or equal to 0.35.

2. The coated active material according to claim 1, wherein the thickness is greater than or equal to 5 nm and less than or equal to 47 nm.

3. The coated active material according to claim 1, wherein the first solid electrolyte comprises a crystal phase in which a peak is present in a range of a diffraction angle 2θ of greater than or equal to 11.05° and less than or equal to 13.86° in an X-ray diffraction pattern obtained by X-ray diffraction measurement using the Cu-Kα line.

4. The coated active material according to claim 1, wherein the molar ratio Li/M1 is greater than or equal to 0.96 and less than or equal to 1.20.

5. The coated active material according to claim 1, wherein X1 is Cl.

6. The coated active material according to claim 1, wherein the active material is a positive electrode active material.

7. The coated active material according to claim 6, wherein the positive electrode active material is a composite oxide comprising Ni and Co.

8. The coated active material according to claim 6, wherein the positive electrode active material includes a reaction inhibition layer consisting of an oxide.

9. A positive electrode material comprising:
the coated active material according to claim 6; and
a second solid electrolyte.

10. The positive electrode material according to claim 9, wherein the second solid electrolyte is an oxyhalide solid electrolyte.

11. The positive electrode material according to claim 10, wherein the oxyhalide solid electrolyte has a same composition as the first solid electrolyte.

12. The positive electrode material according to claim 10, wherein the oxyhalide solid electrolyte has a different composition from the first solid electrolyte.

13. The positive electrode material according to claim 10, wherein
the oxyhalide solid electrolyte comprises Li, M1, M2, O, and X2,
M2 is at least one selected from the group consisting of Zr, Y, La, and Al, and
X2 is at least one selected from the group consisting of F, Cl, Br, and I.

14. The positive electrode material according to claim 13, wherein the oxyhalide solid electrolyte comprises a crystal phase having a peak in a range of a diffraction angle 2θ of greater than or equal to 11.08° and less than or equal to 15.63° in an X-ray diffraction pattern obtained by X-ray diffraction measurement using the Cu-Kα line.

15. The positive electrode material according to claim 13, wherein X2 is at least one selected from the group consisting of Cl and Br.

16. The positive electrode material according to claim 13, wherein a molar ratio of M2 to a total of M1 and M2 is greater than zero and less than or equal to 0.60.

17. The positive electrode material according to claim 13, wherein a molar ratio of F to X2 is greater than or equal to zero and less than or equal to 0.50.

18. A battery comprising:
a positive electrode comprising the positive electrode material according to claim 9;
a negative electrode; and
an electrolyte layer disposed between the positive electrode and the negative electrode.
